(19) United States
(12) Patent Application Publication
(10) Pub. No.: US 2016/0062524 A1
(43) Pub. Date: Mar. 3, 2016

(54) INTEGRATION SHEET, METHOD FOR MANUFACTURING THE SAME AND METHOD FOR MANUFACTURING A TOUCH SCREEN USING THE SAME

(71) Applicants: BOE TECHNOLOGY GROUP CO., LTD., Beijing (CN); BOE (HEBEI) MOBILE DISPLAY TECHNOLOGY CO., LTD., Hebei (CN)

(72) Inventors: Yuejia TANG, Beijing (CN); Dawei ZHOU, Beijing (CN); Yelei XIA, Beijing (CN); Yanhui SONG, Beijing (CN); Peng WANG, Beijing (CN); Jianfeng ZHOU, Beijing (CN); Wei QU, Beijing (CN); Hongqiang FAN, Beijing (CN)

(21) Appl. No.: 14/569,074

(22) Filed: Dec. 12, 2014

(30) Foreign Application Priority Data
Aug. 28, 2014 (CN) 201410431579.7

(51) Int. Cl. G06F 3/041; B32B 37/12; B32B 38/10

(52) U.S. Cl. CPC G06F 3/0412; B32B 38/10; B32B 37/12; B32B 2457/208; G06F 2203/04103

(57) ABSTRACT

Embodiments of the disclosure disclose an integration sheet, a method for manufacturing the same and a method for manufacturing a touch screen using the same. The integration sheet comprises a polarizing sheet and an optically clear adhesive attaching with each other, a release film provided on a side of the optically clear adhesive away from the polarizing sheet and another release film provided on a side of the polarizing sheet away from the optically clear adhesive.

### TECHNICAL FIELD

Embodiments of the disclosure relate to an integration sheet, a method for manufacturing the same and a method for manufacturing a touch screen using the same.

### BACKGROUND

Liquid crystal display panel is mainly composed of an array substrate, an opposite substrate and a liquid crystal layer provided therebetween. Following a completion of assembly of the array substrate and the opposite substrate to obtain the liquid crystal display, a touch screen is formed by attaching a polarizing sheet on the surface of liquid crystal display panel, mounting a driving chip or a flexible circuit board on the liquid crystal display panel, attaching an optically clear adhesive (OCA) as an adhesive on the polarizing sheet, and finally attaching a touch panel on the optically clear adhesive.

It can be seen that the aforementioned touch screen forming process is complex and comprises three attaching processes, which is not conducive to improve the productivity. Also, in the touch screen forming process, four films are stripped in total as follows: firstly, a release film is necessary to be stripped from a polarizing sheet roll as shown in FIG. 1a before attaching the polarizing sheet onto the surface of the liquid crystal display panel; then, a protective film is necessary to be stripped from the polarizing sheet roll and a release film is necessary to be stripped from an optically clear adhesive roll as shown in FIG. 1b before attaching the optically clear adhesive onto the surface of the polarizing sheet; and then a release film is necessary to be stripped from the other side of the optically clear adhesive roll before attaching the touch panel onto the optically clear adhesive. Since four films are stripped, a waste of resources occurs. Furthermore, folds, bubbles and so forth may occur in the aforementioned attaching processes; in particular, folds, bubbles and so forth tend to occur in the process of attaching the optically clear adhesive onto the polarizing sheet. In addition, the touch screen generally is detected after it is finally formed, which hence is not conducive to improve the product yield.

### SUMMARY

According to embodiments of the disclosure, an integration sheet for a touch screen is provided. The integration sheet comprises a polarizing sheet and an optically clear adhesive attaching with each other, a release film provided on a side of the optically clear adhesive away from the polarizing sheet and another release film provided on a side of the polarizing sheet away from the optically clear adhesive.

According to embodiments of the disclosure, a method for manufacturing an integration sheet for a touch screen is provided. The method comprises: attaching a polarizing sheet and an optically clear adhesive with each other; forming a release film on a side of the optically clear adhesive away from the polarizing sheet; and forming another release film on a side of the polarizing sheet away from the optically clear adhesive.

For example, the method comprises: stripping a protective film from a polarizing sheet roll and stripping a release film on one side of an optically clear adhesive roll, wherein the polarizing sheet roll comprises the polarizing sheet, and the protective film and a release film respectively provided on both sides of the polarizing sheet, and the optically clear adhesive roll comprises the optically clear adhesive and two release films respectively provided on both sides of the optically clear adhesive; and attaching the polarizing sheet roll with the protective film being stripped and the optically clear adhesive roll with the release film on one side thereof being stripped to form the integration sheet.

For example, the polarizing sheet roll with the protective film being stripped and the optically clear adhesive roll with the release film on one side thereof being stripped are attached by a roll-to-roll process or a sheet-to-sheet process.

For example, the method comprises: coating the optically clear adhesive on one surface of the polarizing sheet; respectively forming release films on the side of the optically clear adhesive away from the polarizing sheet and on the side of the polarizing sheet away from the optically clear adhesive to form the integration sheet.

For example, the release films are respectively formed on the side of the optically clear adhesive away from the polarizing sheet and on the side of the polarizing sheet away from the optically clear adhesive by a roll-to-roll process or a sheet-to-sheet process.

For example, the coating the optically clear adhesive on one surface of the polarizing sheet comprising: coating a sheet-like optically clear adhesive or a liquid optically clear adhesive on one surface of the polarizing sheet.

For example, the method further comprises: cutting the integration sheet after the integration sheet is formed.

According to embodiments of the disclosure, a method for manufacturing a touch screen using an integration sheet is provided. The integration sheet comprises: a polarizing sheet and an optically clear adhesive attaching with each other, a release film provided on a side of the optically clear adhesive away from the polarizing sheet and another release film provided on a side of the polarizing sheet away from the optically clear adhesive. The method comprises: stripping, from the integration sheet, the release film provided on the side of the polarizing sheet away from the optically clear adhesive; attaching the polarizing sheet of the integration sheet onto a light extraction side of a liquid crystal display panel; stripping, from the integration sheet, the release film provided on the side of the optically clear adhesive away from the polarizing sheet; and attaching a touch panel onto the optically clear adhesive of the integration sheet.

For example, the method further comprises mounting a driving chip or a flexible circuit board on the liquid crystal display panel after attaching the polarizing sheet of the integration sheet onto the light extraction side of the liquid crystal display panel and prior to stripping from the integration sheet the release film provided on the side of the optically clear adhesive away from the polarizing sheet.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1a is a structural schematic view illustrating a polarizing sheet roll in the prior art;

FIG. 1b is a structural schematic view illustrating an optically clear adhesive roll in the prior art;

FIG. 2 is a structural schematic view illustrating an integration sheet according to the embodiments of the disclosure; and

FIG. 3a-FIG. 3c are schematic views illustrating a method for manufacturing a touch screen using the integration sheet according to the embodiments of the disclosure.

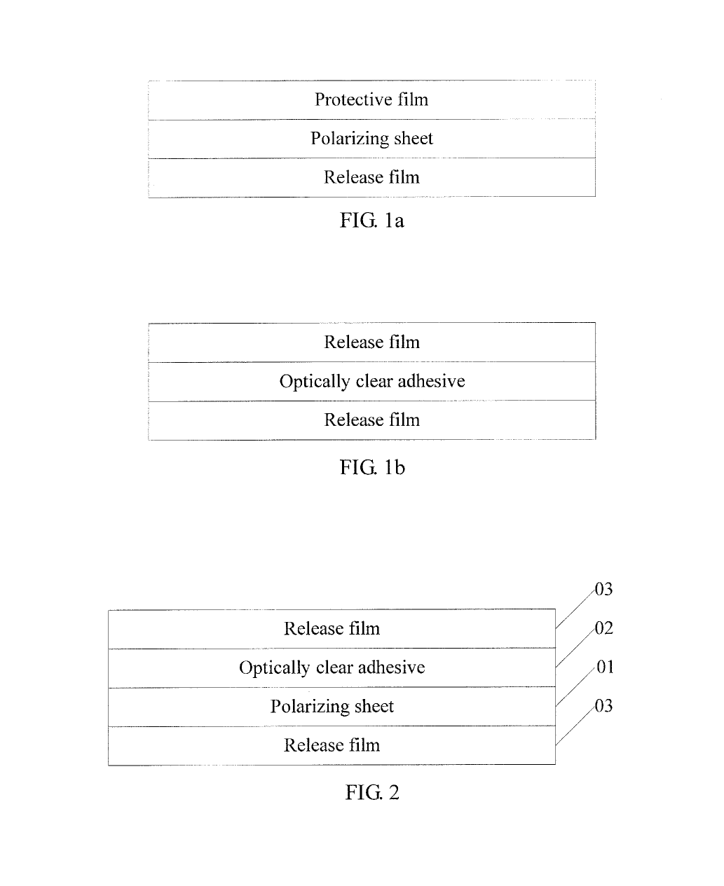

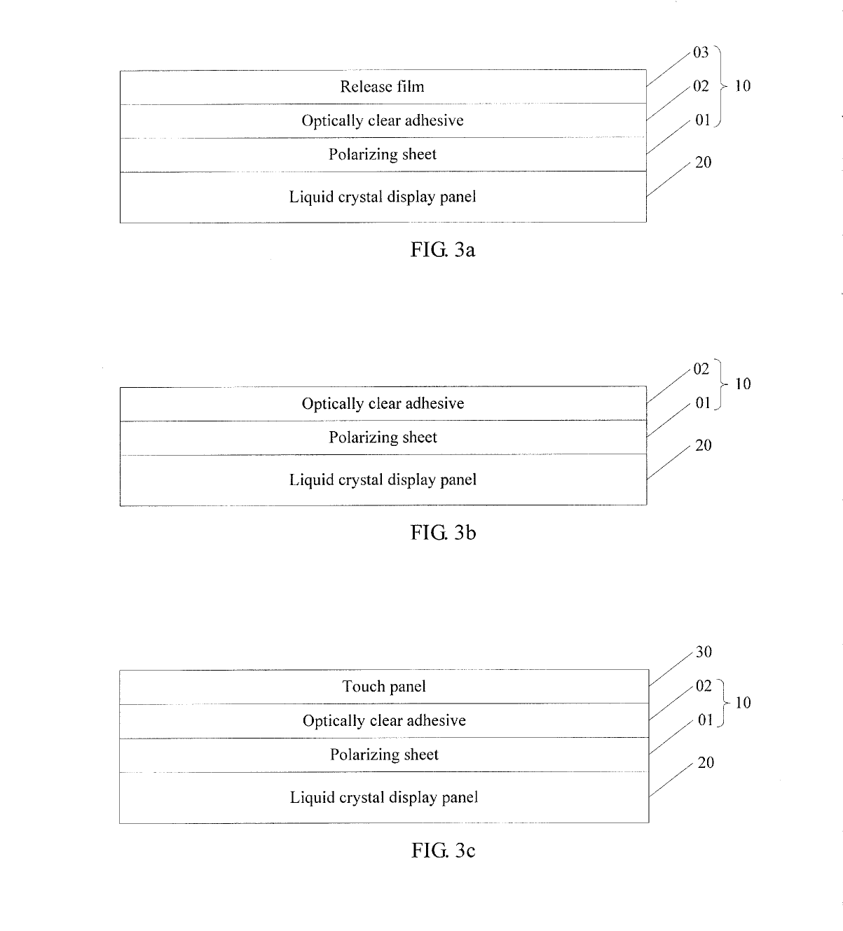

### DETAILED DESCRIPTION

In order to make objects, technical details and advantages of the embodiments of the disclosure apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

It should be noted that, thicknesses and shapes of respective films in the drawings do not reflect the real proportion of the integration sheet according to the embodiments of the disclosure.

Embodiments of the disclosure provide an integration sheet. As shown in FIG. 2, the integration sheet comprises a polarizing sheet 01 and an optically clear adhesive 02 attaching with each other, a release film 03 provided on a side of the optically clear adhesive 02 away from the polarizing sheet 01 and another release film 03 provided on a side of the polarizing sheet 01 away from the optically clear adhesive 02. For example, the integration sheet according to the embodiments of the disclosure is suitable for a touch screen.

In the aforementioned integration sheet according to the embodiments of the disclosure, the polarizing sheet and the optically clear adhesive are provided in the same integration sheet, which facilitates an individual detection of the integration sheet and is conducive to improve the product yield of the finally-formed touch screen. Further, when the aforementioned integration sheet is used to manufacture the touch screen, merely two attaching processes are needed. Compared with the prior art in which three attaching processes are employed, the apparatus for implementing the attaching process is saved, the productivity is improved, and the waste of resources is reduced for merely two films are stripped in the attaching processes.

Further, embodiments of the disclosure provide a method for manufacturing a touch screen using the aforesaid integration sheet. The method comprises the following steps:

S301. stripping, from the integration sheet 10, the release film 03 provided on the side of the polarizing sheet 01 away from the optically clear adhesive 02;

S302. attaching the polarizing sheet 01 of the integration sheet 10 onto a light extraction side of a liquid crystal display panel 20, as shown in FIG. 4a;

S303. stripping, from the integration sheet 10, the release film 03 provided on the side of the optically clear adhesive 02 away from the polarizing sheet 01, as shown in FIG. 4b;

S304. attaching a touch panel 30 onto the optically clear adhesive 02 of the integration sheet 10, as shown in FIG. 4c.

In the method for manufacturing the touch screen using the integration sheet according to the embodiments of the disclosure, the touch screen is manufactured by attaching the integration sheet onto the light extraction side of the liquid crystal display panel after stripping the release film provided on the side of the polarizing sheet away from the optically clear adhesive and attaching the touch panel onto the optically clear adhesive of the integration sheet after stripping the release film provided on the side of the optically clear adhesive away from the polarizing sheet. That is, merely two attaching processes are needed. Compared with the prior art in which three attaching processes are employed, the apparatus for implementing the attaching process is saved so that the manufacturing cost is reduced, the productivity is improved, and the waste of resources is reduced for merely two films are stripped in the attaching processes. Further, an individual detection of the integration sheet is possible to be performed prior to attaching the integration sheet onto the liquid crystal display panel, which is also conducive to improve the product yield.

Further, in the aforesaid method for manufacturing the touch screen according to the embodiments of the disclosure, a driving chip or a flexible circuit board may be mounted on the liquid crystal display panel after step S302 and prior to step S303.

Further, embodiments of the disclosure provide a method for manufacturing the integration sheet.

For example, the method for manufacturing the integration sheet in accordance with the embodiments of the disclosure comprise the following steps:

S501. stripping a protective film from a polarizing sheet roll and stripping a release film on one side of an optically clear adhesive roll. The polarizing sheet roll comprises a polarizing sheet, and the protective film and a release film respectively provided on both sides of the polarizing sheet, and the optically clear adhesive roll comprises an optically clear adhesive and two release films respectively provided on both sides of the optically clear adhesive.

S502. attaching the polarizing sheet roll with the protective film being stripped and the optically clear adhesive roll with the release film on one side thereof being stripped by a roll-to-roll process or a sheet-to-sheet process to form the integration sheet.

For example, purchasable polarizing sheet roll and purchasable optically clear adhesive roll are employed in the above method for manufacturing the integration sheet. The purchasable polarizing sheet roll with the protective film being stripped and the purchasable optically clear adhesive roll with the release film on one side thereof being stripped are attached with each other to form the integration sheet. It should be noted that the aforesaid steps S501 and S502 are accomplished in a clean room.

In addition, the method for manufacturing the integration sheet according to the embodiments of the disclosure further comprises a step of cutting the integration sheet according to a predetermined size. For example, after the integration sheet is formed, the integration sheet is cut according to a size of the liquid crystal display panel on which the integration sheet to be attached.

Further, since the protective film and the release film are stripped prior to cutting the integration sheet (i.e., the stripped protective film and the release film are not cut), the protective film and the release film being stripped during the above manufacture process can be repeatedly used (i.e., they can be repeatedly used for manufacturing the polarizing sheet roll and the optically clear adhesive roll). Thus, compared with the case in which the protective film and the release film that have been cut are stripped, the manufacture cost is reduced.

Alternatively, the method for manufacturing the integration sheet according to the embodiments of the disclosure comprise the following steps:

S601. coating the optically clear adhesive on one surface of the polarizing sheet.

For example, a sheet-like optically clear adhesive or a liquid optically clear adhesive is coated on one surface of the polarizing sheet.

S602. respectively forming release films on the side of the optically clear adhesive away from the polarizing sheet and on the side of the polarizing sheet away from the optically clear adhesive using the roll-to-roll process or sheet-to-sheet process to form the integration sheet.

Similarly, the above method for manufacturing the integration sheet further comprises a step of cutting the integration sheet according to a predetermined size. For example, after the integration sheet is formed, the integration sheet is cut according to a size of the liquid crystal display panel on which the integration sheet to be attached. It should be noted that the above steps S601 and S602 are accomplished in the clean room.

The embodiments of the disclosure provide the integration sheet, the method for manufacturing the integration sheet and the method for manufacturing the touch screen using the integration sheet, and the integration sheet is composed of the polarizing sheet and the optically clear adhesive attaching with each other, and release films respectively provided on the external sides of the polarizing sheet and the optically clear adhesive. In the case of manufacturing the touch screen by using the integration sheet, the touch screen is manufactured by attaching the integration sheet onto the light extraction side of the liquid crystal display panel after stripping the release film provided on the side of the polarizing sheet away from the optically clear adhesive and attaching the touch panel onto the optically clear adhesive of the integration sheet after stripping the release film provided on the side of the optically clear adhesive away from the polarizing sheet. Compared with the prior art in which three attaching processes are employed, merely two attaching processes are needed. Thus, the apparatus for implementing the attaching process is saved so that the manufacturing cost is reduced, the productivity is improved, and the waste of resources is reduced for merely two films are stripped in the attaching processes. Further, an individual detection of the integration sheet is possible to be performed prior to attaching the integration sheet onto the liquid crystal display panel, which is also conducive to improve the product yield.

The foregoing embodiments merely are exemplary embodiments of the disclosure, and not intended to define the scope of the disclosure, and the scope of the disclosure is determined by the appended claims.

The disclosure claims priority to and contains subject matters related to that disclosed in Chinese Priority Patent Application CN201410431579.7 filed on Aug. 28, 2014, the entire content of which is hereby incorporated by reference.

What is claimed is:

1. An integration sheet for a touch screen, comprising a polarizing sheet and an optically clear adhesive attaching with each other, a release film provided on a side of the optically clear adhesive away from the polarizing sheet and another release film provided on a side of the polarizing sheet away from the optically clear adhesive.

2. A method for manufacturing an integration sheet for a touch screen, comprising:
attaching a polarizing sheet and an optically clear adhesive with each other;
forming a release film on a side of the optically clear adhesive away from the polarizing sheet; and
forming another release film on a side of the polarizing sheet away from the optically clear adhesive.

3. The method according to claim 2, comprising:
stripping a protective film from a polarizing sheet roll and stripping a release film on one side of an optically clear adhesive roll, wherein the polarizing sheet roll comprises the polarizing sheet, and the protective film and a release film respectively provided on both sides of the polarizing sheet, and the optically clear adhesive roll comprises the optically clear adhesive and two release films respectively provided on both sides of the optically clear adhesive; and
attaching the polarizing sheet roll with the protective film being stripped and the optically clear adhesive roll with the release film on one side thereof being stripped to form the integration sheet.

4. The method according to claim 3, wherein the polarizing sheet roll with the protective film being stripped and the optically clear adhesive roll with the release film on one side thereof being stripped are attached by a roll-to-roll process or a sheet-to-sheet process.

5. The method according to claim 3, further comprising:
cutting the integration sheet after the integration sheet is formed.

6. The method according to claim 2, comprising:
coating the optically clear adhesive on one surface of the polarizing sheet;
respectively forming release films on the side of the optically clear adhesive away from the polarizing sheet and on the side of the polarizing sheet away from the optically clear adhesive to form the integration sheet.

7. The method according to claim 6, wherein the release films are respectively formed on the side of the optically clear adhesive away from the polarizing sheet and on the side of the polarizing sheet away from the optically clear adhesive by a roll-to-roll process or a sheet-to-sheet process.

8. The method according to claim 6, wherein the coating the optically clear adhesive on one surface of the polarizing sheet comprising:
coating a sheet-like optically clear adhesive or a liquid optically clear adhesive on one surface of the polarizing sheet.

9. The method according to claim 6, further comprising:
cutting the integration sheet after the integration sheet is formed.

10. A method for manufacturing a touch screen using an integration sheet, the integration sheet comprising: a polarizing sheet and an optically clear adhesive attaching with each other, a release film provided on a side of the optically clear adhesive away from the polarizing sheet and another release film provided on a side of the polarizing sheet away from the optically clear adhesive, wherein the method comprises:
stripping, from the integration sheet, the release film provided on the side of the polarizing sheet away from the optically clear adhesive;
attaching the polarizing sheet of the integration sheet onto a light extraction side of a liquid crystal display panel;
stripping, from the integration sheet, the release film provided on the side of the optically clear adhesive away from the polarizing sheet; and
attaching a touch panel onto the optically clear adhesive of the integration sheet.

11. The method according to claim 10, wherein the method further comprises mounting a driving chip or a flexible circuit board on the liquid crystal display panel after attaching the polarizing sheet of the integration sheet onto the light extraction side of the liquid crystal display panel and prior to stripping from the integration sheet the release film provided on the side of the optically clear adhesive away from the polarizing sheet.
